(19) United States
(12) Patent Application Publication
(10) Pub. No.: US 2023/0187792 A1
(43) Pub. Date: Jun. 15, 2023

(54) RECHARGABLE BATTERY CELL

(71) Applicant: SK On Co., Ltd., Seoul (KR)

(72) Inventors: Ji Hyung KIM, Daejeon (KR); Gyu Sik Kim, Daejeon (KR); Jae Sik Shin, Daejeon (KR); Kyung Hee Jeong, Daejeon (KR)

(21) Appl. No.: 17/876,668

(22) Filed: Jul. 29, 2022

(30) Foreign Application Priority Data
Dec. 13, 2021 (KR) 10-2021-0177959

(51) Int. Cl. H01M 50/54; H01M 50/536; H01M 50/15

(52) U.S. Cl. CPC H01M 50/54; H01M 50/536; H01M 50/15

(57) ABSTRACT

A rechargable battery, includes: an electrode assembly; an exterior material disposed to surround the electrode assembly and having both end portions thereof opened; and a cover member disposed on both end portions of the exterior material and having a connection structure for forming electrical connection between the electrode assembly and an external electrode, wherein the external material may include a laminate sheet formed of an aluminum material, the laminate sheet having a thickness of 100 μm or more.

### CROSS-REFERENCE TO RELATED APPLICATION(S)

This application claims the benefit under 35 USC 119(a) of Korean Patent Application No. 10-2021-0177959 filed on Dec. 13, 2021 in the Korean Intellectual Property Office, the entire disclosure of which is incorporated herein by reference for all purposes.

### BACKGROUND

The present disclosure relates to a rechargable battery.

A pouch-type rechargable battery may cause various safety problems due to the low physical robustness of a pouch surrounding an electrode. In addition, there may be a limitation in a forming process for forming the pouch film, so there may be a disadvantage in that it is difficult to manufacture cells of a certain thickness or more.

In order to solve this problem, a prismatic rechargable battery has been employed. Although an external case has a high degree of robustness, it has a disadvantage in terms of energy density.

Therefore, there is a need to develop a new structure capable of and compensating for the disadvantage in terms of energy density while improving ease of manufacturing the cell.

### SUMMARY

An aspect of the present disclosure is to provide a rechargable battery capable of improving physical stability.

An aspect of the present disclosure is to provide a rechargable battery capable of improving energy density while increasing ease of manufacturing.

In addition, an aspect of the present disclosure is to provide a rechargable battery capable of improving convenience of an assembly process of a connection structure and a positive electrode lead, and a connection structure and a negative electrode lead.

According to an aspect of the present disclosure, a rechargable battery may include: an electrode assembly; an exterior material disposed to surround the electrode assembly and having both end portions thereof opened; and a cover member disposed on both end portions of the exterior material and having a connection structure for forming electrical connection between the electrode assembly and an external electrode, wherein the external material includes a laminate sheet formed of an aluminum material, the laminate sheet having a thickness of 100 μm or more.

The exterior material and the cover member may be coupled to have a rectangular parallelepiped shape.

The laminate sheet may have a thickness of 200 μm or less.

The electrode assembly may include a negative electrode lead disposed on a side of one end portion of the exterior material and a negative electrode lead disposed on a side of the other end portion of the exterior material.

The cover member may include a first cover member disposed on one end portion of the exterior material to be electrically connected to the negative electrode lead, and a second cover member disposed on the other end portion of the exterior material to be electrically connected to the positive electrode lead.

The connection structure may include a first connection structure connected to the negative electrode lead and provided on the first cover member, and a second connection structure connected to the positive electrode lead and provided on the second cover member.

The first connection structure may include a first insertion groove into which an end portion of the negative lead is inserted, and the second connection structure may include a second insertion groove into which an end portion of the positive lead is inserted.

The first connection structure and the negative electrode lead, and the second connection structure and the positive electrode lead may be bonded by ultrasonic welding.

The first cover member may include a first terminal connected to the first connection structure and exposed externally of the first cover member, and the second cover member may include a second terminal connected to the second connection structure and exposed externally of the second cover member.

The first terminal may be disposed on a first plate portion of the first cover member covering one end portion of the exterior material, and the second terminal may be disposed on a second plate portion of the second cover member covering the other end portion of the exterior material.

The exterior material may include an installation groove through which the first and second terminals are exposed externally, and two of the installation grooves may be disposed on one surface of the exterior material to be spaced apart from each other.

The first terminal may be disposed on one surface of a first extension portion of the first cover member, and the second terminal may be disposed on one surface of a second extension portion of the second cover member.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view illustrating a rechargable battery according to an embodiment of the present disclosure.

FIG. 2 is a configuration diagram illustrating a rechargable battery according to an embodiment of the present disclosure.

FIG. 3 is a view illustrating connection between a cover member and a positive electrode lead of a rechargable battery according to an embodiment of the present disclosure.

FIG. 4 is a schematic perspective view illustrating a rechargable battery according to an embodiment of the present disclosure.

FIG. 5 is a configuration diagram illustrating a rechargable battery according to an embodiment of the present disclosure.

FIG. 6 is a view illustrating connection between a cover member and a positive electrode lead of a rechargable battery according to an embodiment of the present disclosure.

### DETAILED DESCRIPTION

Hereinafter, embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clarity of description, and elements indicated by the same reference numeral are same elements in the drawings.

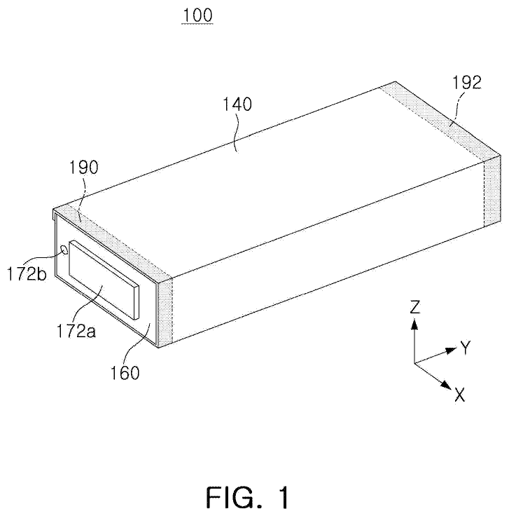

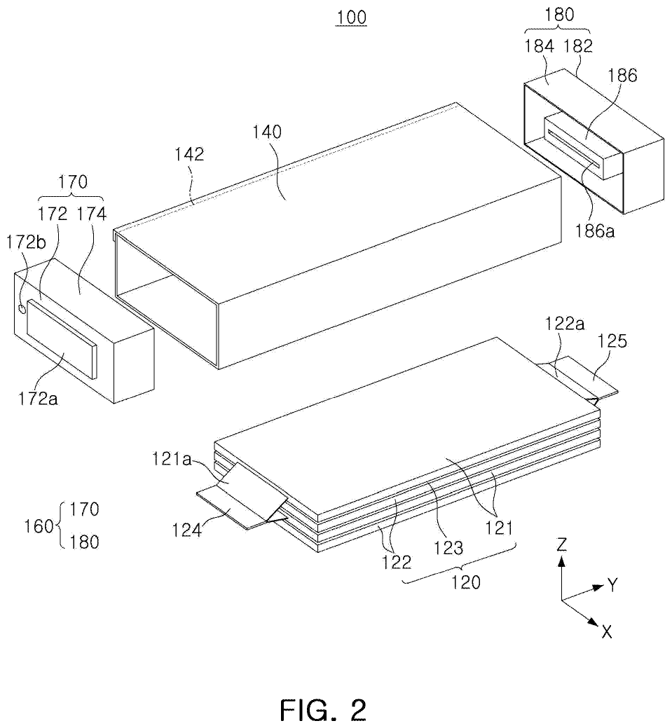

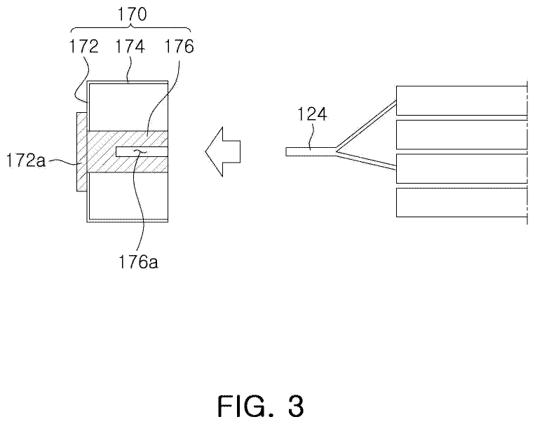

FIG. 1 is a schematic perspective view illustrating a rechargable battery according to an embodiment of the present disclosure, FIG. 2 is a configuration diagram illustrating a rechargable battery according to an embodiment of the present disclosure, and FIG. 3 is an explanatory diagram for illustrating connection between a cover member and a positive electrode lead of a rechargable battery according to an embodiment of the present disclosure.

Referring to FIGS. 1 to 3, a rechargable battery 100 according to an embodiment of the present disclosure may include an electrode assembly 120 (refer to FIG. 2), and an exterior material 140, and a cover member 160 (refer to FIG. 2).

The electrode assembly 120 is accommodated in the exterior material 140. As an example, the electrode assembly 120 includes a first electrode plate 121, a second electrode plate 122, and a separator 123 formed in a thin plate shape or a film shape, and may be formed in various forms as needed, such as a stacked, wound type, or the like. For example, the first electrode plate 121 may serve as a negative electrode, and the second electrode plate 122 may serve as a positive electrode.

The first electrode plate 121 may be formed by coating a first electrode active material such as graphite or carbon on a first electrode current collector formed of, for example, a metal foil such as copper, a copper alloy, nickel, or a nickel alloy. In addition, the first electrode plate 121 includes a first electrode uncoated region 121a, a region on which the first electrode active material is not applied. The first electrode uncoated region 121a serves as a path for current flow between the first electrode plate 121 and an exterior of the first electrode plate 121.

The second electrode plate 122 may be formed by coating a second electrode active material such as graphite or carbon on a second electrode current collector formed of, for example, a metal foil such as copper, a copper alloy, nickel, or a nickel alloy. In addition, the second electrode plate 122 includes a second electrode uncoated region 122a, a region on which the second electrode active material is not applied. The second electrode uncoated region 122a serves as a path for current flow between the second electrode plate 122 and an exterior of the second electrode plate 122.

The separator 123 is positioned between the first electrode plate 121 and the second electrode plate 122 to prevent a short circuit and to serve to enable movement of lithium ions. For example, the separator 123 may be formed of polyethylene, polypropylene, or a composite film of polyethylene and polypropylene.

As an example, the first electrode plate 121, the second electrode plate 122, and the separator 123 may be arranged in a height direction of the exterior material 140. In other words, the first electrode plate 121, the separator 123, and the second electrode plate 122 may be alternately stacked in a Z-axis direction of FIG. 1.

The negative electrode lead 124 is connected to the uncoated region 121a of the first electrode plate 121, and the positive electrode lead 125 is connected to the uncoated region 122a of the second electrode plate 122.

The exterior material 140 is disposed to surround the electrode assembly 120 so that both end portions of the electrode assembly 120 are exposed. In other words, the negative electrode lead 124 and the positive electrode lead 125 of the electrode assembly 120 are disposed externally through openings formed on both end portions of the exterior material 140.

Meanwhile, an overlapping portion 142 may be formed in a region in which the exterior material 140 is disposed in a longitudinal direction of the electrode assembly 120, that is, in a region in which the exterior material 140 overlaps. The overlapping portion 142 may be thermally fused and bondedbonded by heating and pressing or may be bondedbonded by an adhesive, and accordingly, the overlapping portion 142 serves to seal an internal space formed by the exterior portion 140. The exterior material 140 may be formed of a laminate sheet including a metal layer and a resin layer. In particular, the laminate sheet may be an aluminum laminate sheet. As an example, the exterior material 140 may include a core portion formed of a metal layer, a heat-sealing layer formed on an upper surface of the core portion, and an insulating film formed on a lower surface of the core portion.

The heat-sealing layer acts as an adhesive layer using a polymer resin, such as modified polypropylene, for example, CPP (Casted Polypropylene). The insulating film may be formed of a resin material such as nylon or polyethylene terephthalate (PET), but the structure and material of the exterior material are not limited here.

As an example, the exterior material 140 may have a rectangular parallelepiped shape and having both end portions thereof opened.

In addition, the exterior material 140 may have a thickness of 100 μm or more of a laminate sheet formed of an aluminum material provided on the exterior material 140 for strength reinforcement. Accordingly, the strength of the exterior material 140 may be improved compared to that of the conventional exterior material 140. However, when the thickness of the laminate sheet is 200 μm or more, since moldability may be lowered, it may not be preferable to increase the thickness of the laminate sheet to 200 μm or more.

As described above, physical robustness of the rechargable battery 100 may be improved by increasing the strength of the exterior material 140.

The cover member 160 is disposed on both end portions of the exterior member 140. Meanwhile, the cover member 160 may be formed of a material different from that of the exterior material 140. As an example, the cover member 160 may be formed of a material that can prevent damage by an electrolyte, for example, the cover member 160 may be formed of a polypropylene (PP) material.

Meanwhile, the cover member 160 may include a first cover member 170 disposed on one end portion of the exterior material 140 and a second cover member 180 disposed on the other end portion of the exterior material 140.

The first cover member 170 may include a first plate portion 172 and a first extension portion 174 formed to extend from the first plate portion 172 toward the exterior material 140. As an example, the first extension portion 174 may be insertedly disposed in an internal space of the exterior material 140.

A first terminal 172a for electrical connection with an external electrode may be provided on the first plate portion 172. The first terminal 172a may be disposed in a Y-axis direction of FIG. 2, and may have a substantially rectangular plate shape. The first terminal 172a may be formed of, for example, a conductive material. Meanwhile, a first through-hole 172b may be provided on the first plate portion 172, and the first through-hole 172b may serve as an electrolyte injection hole and/or a venting hole. In addition, the first through-hole 172b may be closed by a first sealing member (not shown).

The first cover member 170 may include a first connection structure 176 for electrical connection between the negative electrode lead 124 of the electrode assembly 120 and the first terminal 172a. A first insertion groove 176a into which the negative electrode lead 124 is inserted may be provided in the first connection structure 176. As an example, the first connection structure 176 and the negative lead 124 may be bonded by ultrasonic welding.

Meanwhile, the first connection structure 176 and the first terminal 172a may be integrally formed or may be separately manufactured and bonded. In addition, the first connection structure 176 and the first terminal 172a may be formed of the same material.

The first cover member 170 and the exterior material 140 may be bonded and installed by a first sealing portion 190. As an example, the first sealing portion 190 may be an adhesive for bonding and installing the first cover member 170 and the exterior material 140. However, the present disclosure is not limited thereto, and the first sealing portion 190 may refer to a region in which the first cover member 170 and the exterior material 140 are thermally fused and bonded by heating and pressing.

Meanwhile, the second cover member 180 may include a second plate portion 182 and a second extension portion 184 formed to extend from the second plate portion 182 toward the exterior material 240. As an example, the second extension portion 184 may be insertedly disposed in an internal space of the exterior material 240.

A second terminal (not shown) for electrical connection with an external electrode may be provided on the second plate portion 182. The second terminal may be disposed in a Y-axis direction of FIG. 2 and may have a substantially rectangular plate shape. The second terminal may be formed of, for example, a conductive material.

The second cover member 180 may include a second connection structure 186 for forming electrical connection between the positive electrode lead 125 and the second terminal. The second connection structure 186 may include a second insertion groove 186a into which the positive electrode lead 125 is inserted. As an example, the second connection structure 186 and the positive electrode lead 125 may be bonded by ultrasonic welding.

Meanwhile, the second connection structure 186 and the second terminal may be integrally formed or may be separately manufactured and bonded. In addition, the second connection structure 186 and the second terminal may be formed of the same material.

The second cover member 180 and the exterior material 140 may be bonded and installed by a second sealing portion 192. As an example, the second sealing portion 192 may be an adhesive for bonding and installing the second cover member 180 and the exterior material 140. However, the present disclosure is not limited thereto, and the second sealing portion 192 may refer to a region in which the second cover member 180 and the exterior material 140 are thermally fused and bonded by heating and pressing.

When the cover member 160 is coupled to the exterior material 140, the exterior material 140 and the cover member 160 may have a rectangular parallelepiped shape like a prismatic rechargable battery. Accordingly, the rechargable battery 100 may improve energy density of the rechargable battery 100 by compensating for disadvantages in terms of the energy density.

Meanwhile, an electrolyte may be filled in the internal space formed by the exterior material 140 and the cover member 160. As an example, the electrolyte may be formed of a lithium salt such as LiPF₆ or LiPF₆ in an organic solvent such as ethylene carbonate (EC), propylene carbonate (PC), diethyl carbonate (DEC), ethylmethyl carbonate (EMC), or dimethyl carbonate (DMC). In addition, the electrolyte may be in a liquid or gel form.

As described above, since the thickness of the laminate sheet provided on the exterior material 140 is 100 μm or more, the strength of the exterior material 140 may be improved. Accordingly, the physical stability of the rechargable battery 100 may be improved.

It is possible to increase a volume of the electrode assembly 120 disposed inside the exterior material 140 while increasing ease of manufacturing the rechargable battery 100 through the exterior material 140 having improved strength. Accordingly, the energy density of the rechargable battery 100 may be improved.

Furthermore, by inserting the negative electrode lead 124 and the positive electrode lead 125 into the first and second insertion grooves 176a and 186a of the first and second connection structures 176 and 186, to connect the negative electrode lead 124 and the positive electrode lead 125 to the first and second connection structures 176 and 186, the convenience of the assembly process may be improved.

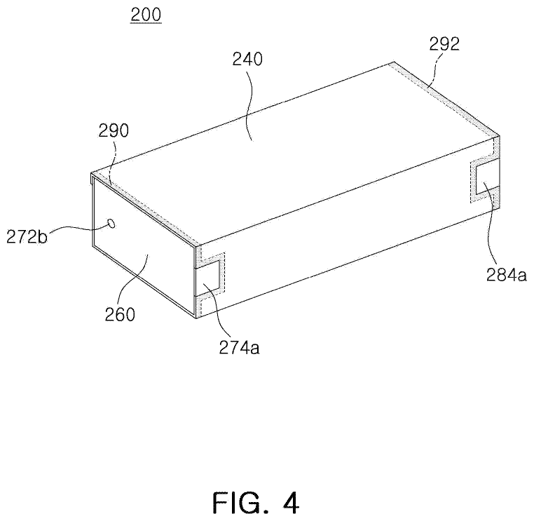

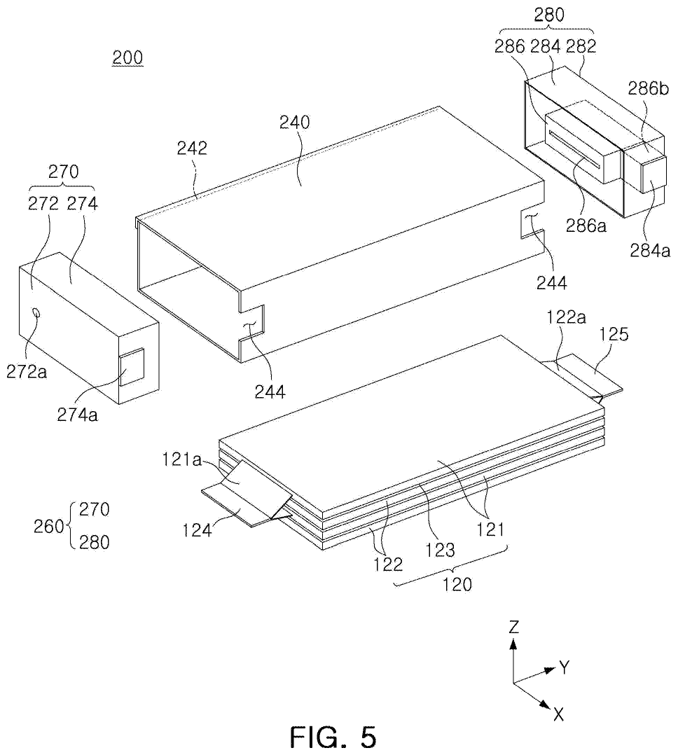

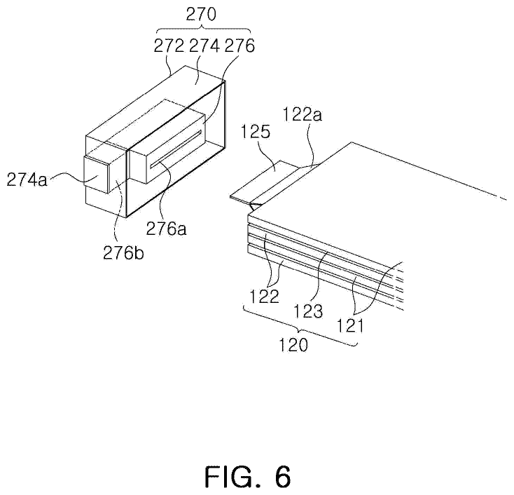

FIG. 4 is a schematic perspective view illustrating a rechargable battery according to an embodiment of the present disclosure, FIG. 5 is a configuration diagram illustrating a rechargable battery according to an embodiment of the present disclosure, and FIG. 6 is a view illustrating connection between a cover member and a positive electrode lead of a rechargable battery according to an embodiment of the present disclosure.

Referring to FIGS. 4 to 6, a rechargable battery 100 according to the embodiment of the present disclosure may include, as an example, an electrode assembly 120 (refer to FIG. 5), an exterior material 240, and a cover member 260 (refer to FIG. 5).

Meanwhile, since the electrode assembly 120 is substantially the same as the above-described components, a detailed description thereof will be omitted and will be replaced with the above description.

Meanwhile, an overlapping portion 242 may be formed in a region in which the exterior material 240 is disposed in a longitudinal direction of the electrode assembly 120, that is, in a region in which the exterior material 240 overlaps and is disposed. The overlapping portion 242 may be thermally fused and bonded by heating and pressing or may be bonded by an adhesive, and thus the overlapping portion 242 serves to seal an internal space formed by the exterior portion 240. The exterior material 240 may be formed of a laminate sheet including a metal layer and a resin layer. In particular, the laminate sheet may be an aluminum laminate sheet. As an example, the exterior material 240 may include a core portion having a material thereof formed of a metal layer, a heat-sealing layer formed on an upper surface of the core portion, and an insulating film formed on a lower surface of the core portion.

The heat-sealing layer acts as an adhesive layer using a polymer resin, such as modified polypropylene, for example, Cast Polypropylene (CPP). The insulating film may be formed of a resin material such as nylon or polyethylene terephthalate (PET), but the structure and material of the exterior material are not limited here.

In addition, the exterior material 240 may have a thickness of 100 μm or more of a laminate sheet formed of an aluminum material provided in the exterior material 240 for strength reinforcement. Accordingly, the strength of the exterior material 240 may be improved compared to the strength of the conventional exterior material 240. However, when the thickness of the laminate sheet is 200 μm or more, since moldability may be lowered, it may not be preferable to increase the thickness of the laminate sheet to 200 μm or more.

As described above, physical robustness of the rechargable battery 200 may be improved by increasing the strength of the exterior material 240.

Meanwhile, an installation groove 244 may be disposed in at least one of side surfaces of the exterior material 240 disposed in an X-axis direction. Thereby, first and second terminals 274a and 284a, to be described later, may be disposed to be exposed externally. A detailed description thereof will be provided later.

The cover member 260 is disposed on both end portions of the exterior member 240. Meanwhile, the cover member 260 may be formed of a material different from that of the exterior material 240. As an example, the cover member 260 may be formed of a material that can prevent damage by an electrolyte, for example, the cover member 260 may be formed of a polypropylene (PP) material.

Meanwhile, the cover member 260 may include a first cover member 270 disposed on an end portion of the exterior material 240 and a second cover member 280 disposed on the other end portion of the exterior material 240.

The first cover member 270 may include a first plate portion 272 and a first extension portion 274 formed to extend from the first plate portion 272 toward the exterior material 240. As an example, the first extension portion 274 may be insertedly disposed in an internal space of the exterior material 240.

Meanwhile, the first extension portion 274 may include a first terminal 274a for forming electrical connection thereof with an external electrode. The first terminal 274a may be disposed in an X-axis direction of FIG. 4, and may have a substantially square plate shape. The first terminal 274a may be formed of, for example, a conductive material. When the first cover member 270 is installed in the exterior material 240, the first terminal 274a is disposed in an installation groove 244 of the exterior material 240. Accordingly, the first terminal 274a may be exposed externally of the exterior material 240.

The first plate portion 272 may include a first through-hole 272a. The first through hole 272a may serve as an electrolyte injection hole and/or a venting hole. The first through-hole 272a may be closed by a first sealing member (not shown).

The first cover member 270 may include a first connection structure 276 for forming electrical connection between the negative electrode lead 124 of the electrode assembly 120 and the first terminal 274a. The first connection structure 276 may include a first insertion groove 276a into which the negative electrode lead 124 is inserted. As an example, the first connection structure 276 and the negative electrode lead 124 may be bonded by ultrasonic welding. Meanwhile, the first connection structure 276 may include a first connection portion 276b extending from a side surface thereof and connected to the first terminal 274a.

Meanwhile, the first connection structure 276 and the first terminal 274a may be integrally formed, or may be separately manufactured and bonded. In addition, the first connection structure 276 and the first terminal 274a may be formed of the same material.

The first cover member 270 and the exterior material 240 may be bonded and installed by a first sealing portion 290. As an example, the first sealing portion 290 may be an adhesive for bonding and installing the first cover member 270 and the exterior material 240. However, the present disclosure is not limited thereto, and the first sealing portion 290 may refer to a region in which the first cover member 270 and the exterior material 240 are thermally fused and bonded by heating and pressing.

Meanwhile, the second cover member 280 may include a second plate portion 282 and a second extension portion 284 formed to extend from the second plate portion 282 toward the exterior material 240. As an example, the second extension portion 284 may be insertedly disposed in an internal space of the exterior material 240.

Meanwhile, the second extension portion 284 may include a second terminal 284a for forming electrical connection thereof with an external electrode. The second terminal 284a may be disposed in an X-axis direction of FIG. 4, and may have a substantially square plate shape. The second terminal 284a may be formed of, for example, a conductive material. When the second cover member 280 is installed in the exterior material 240, the second terminal 284a is disposed in an installation groove 244 of the exterior material 240. Accordingly, the second terminal 284a may be exposed externally of the exterior material 240.

The second cover member 280 may include a second connection structure 286 for forming electrical connection between the positive electrode lead 125 of the electrode assembly 120 and the second terminal 284a. The second connection structure 286 may include a second insertion groove 286a into which the positive electrode lead 125 is inserted. As an example, the second connection structure 286 and the positive electrode lead 125 may be bonded by ultrasonic welding. Meanwhile, the second connection structure 286 may include a second connection portion 286b extending from a side surface thereof and connected to the second terminal 284a.

Meanwhile, the second connection structure 286 and the second terminal 284a may be integrally formed, or may be separately manufactured and bonded. In addition, the second connection structure 286 and the second terminal 284a may be formed of the same material.

The second cover member 280 and the exterior material 240 may be bonded and installed by a second sealing portion 292. As an example, the second sealing portion 292 may be an adhesive for bonding and installing the second cover member 280 and the exterior material 240. However, the present disclosure is not limited thereto, and the second sealing portion 292 may refer to a region in which the second cover member 280 and the exterior material 240 are thermally fused and bonded by heating and pressing.

As described above, the first terminal 274a and the second terminal 284a may be disposed to be exposed on one surface of the exterior material 240. In other words, the first terminal 274a and the second terminal 284a may be exposed externally through the same surface of the exterior material 240.

As set forth above, according to an embodiment of the present disclosure, physical stability may be improved.

According to an embodiment of the present disclosure, energy density may be improved while increasing ease of manufacturing.

According to an embodiment of the present disclosure, convenience of an assembly process of a connection structure and a positive electrode lead, and a connection structure and a negative electrode lead may be improved.

Hereinafter, the present disclosure will be described in more detail through specific examples. The following examples are only examples to help the understanding of the present disclosure, and the scope of the present disclosure is not limited thereto.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A rechargable battery, comprising:
an electrode assembly;
an exterior material disposed to surround the electrode assembly and having both end portions thereof opened; and
a cover member disposed on both end portions of the exterior material and having a connection structure for forming electrical connection between the electrode assembly and an external electrode,
wherein the external material includes a laminate sheet formed of an aluminum material, the laminate sheet having a thickness of 100 μm or more.

2. The rechargable battery of claim 1, wherein the exterior material and the cover member are combined to have a rectangular parallelepiped shape.

3. The rechargable battery of claim 1, wherein the laminate sheet has a thickness of 200 μm or less.

4. The rechargable battery of claim 1, wherein the electrode assembly comprises a negative electrode lead disposed on a side of one end portion of the exterior material and a positive electrode lead disposed on a side of the other end portion of the exterior material.

5. The rechargable battery of claim 4, wherein the cover member comprises a first cover member disposed on one end portion of the exterior material to be electrically connected to the negative electrode lead, and a second cover member disposed on the other end portion of the exterior material to be electrically connected to the positive electrode lead.

6. The rechargable battery of claim 5, wherein the connection structure comprises a first connection structure connected to the negative electrode lead and provided on the first cover member, and a second connection structure connected to the positive electrode lead and provided on the second cover member.

7. The rechargable battery of claim 6, wherein the first connection structure comprises a first insertion groove into which an end portion of the negative electrode lead is inserted, and
the second connection structure comprises a second insertion groove into which an end portion of the positive electrode lead is inserted.

8. The rechargable battery of claim 7, wherein the first connection structure and the negative electrode lead, and the second connection structure and the positive electrode lead are bonded by ultrasonic welding.

9. The rechargable battery of claim 6, wherein the first cover member comprises a first terminal connected to the first connection structure and exposed externally of the first cover member, and
the second cover member comprises a second terminal connected to the second connection structure and exposed externally of the second cover member.

10. The rechargable battery of claim 9, wherein the first terminal is disposed on a first plate portion of the first cover member covering one end portion of the exterior material, and
the second terminal is disposed on a second plate portion of the second cover member covering the other end portion of the exterior material.

11. The rechargable battery of claim 9, wherein the exterior material comprises an installation groove in which the first and second terminals are exposed externally, and
two of the installation grooves are disposed on one surface of the exterior material to be spaced apart from each other.

12. The rechargable battery of claim 11, wherein the first terminal is disposed on one surface of a first extension portion of the first cover member, and
the second terminal is disposed on one surface of a second extension portion of the second cover member.
